(19) United States
(12) Patent Application Publication
(10) Pub. No.: US 2022/0129796 A1
(43) Pub. Date: Apr. 28, 2022

(54) VEHICLE RESERVATION PLATFORM

(71) Applicant: Polaris Industries Inc., Medina, MN (US)

(72) Inventors: Nila J Norman, Medina, MN (US); Ryan R. Painter, Medina, MN (US); Gray I. Rentz, Waconia, MN (US); Nora C. Raisanen, Buffalo, MN (US); Scott E. Colestock, Andover, MN (US)

(21) Appl. No.: 17/511,870

(22) Filed: Oct. 27, 2021

Related U.S. Application Data
(60) Provisional application No. 63/106,627, filed on Oct. 28, 2020.

(51) Int. Cl. G06Q 10/02; G06Q 20/24; G06Q 30/02; G06Q 10/08

(52) U.S. Cl. CPC G06Q 10/02; G06Q 10/087; G06Q 30/0206; G06Q 20/24

(57) ABSTRACT

Aspects of the present disclosure relate to a vehicle reservation platform (VRP). In examples, one or more inventory partners make vehicles available for reservation via the VRP. Accordingly, a customer of the vehicle reservation platform is able to schedule a reservation of an available vehicle. The VRP may offer different subscription tiers, where each subscription tier is associated with a predetermined number of credits for a given time period, potentially on a recurring basis. Accordingly, rather than directly purchasing a vehicle reservation, the customer may exchange credits associated with his or her user account for a vehicle reservation via the VRP. If the user account has an insufficient credit balance, the customer may purchase additional credits in order to address the deficiency. In examples, a credit cost of a vehicle reservation is static or may be determined dynamically based on a variety of factors.

### CROSS-REFERENCE TO RELATED APPLICATION

This application claims priority to U.S. Provisional Application No. 63/106,627, titled “Vehicle Reservation Platform,” filed on Oct. 28, 2020, the entire disclosure of which is hereby incorporated by reference in its entirety.

### BACKGROUND

Access to a special-purpose vehicle may traditionally take the form of vehicle ownership, which may be accompanied by ownership costs, maintenance costs, potentially complex vehicle transport logistics, storage space requirements, and/or storage costs. Accordingly, a user that may otherwise use a special-purpose vehicle may be deterred by such barriers to access.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to a vehicle reservation platform. In examples, one or more inventory partners make vehicles available for reservation via the vehicle reservation platform. Accordingly, a customer of the vehicle reservation platform is able to schedule a reservation of an available vehicle. Multiple reservation types may be offered, for example a pickup reservation type, a delivery reservation type, a guided reservation type, or a self-guided reservation type. Once a customer schedules a reservation via the vehicle reservation platform, the vehicle reservation platform may automatically coordinate with an associated inventory partner in order to facilitate fulfillment of the reservation.

In examples, the customer subscribes to the vehicle reservation platform. The vehicle reservation platform may offer different subscription tiers, where each subscription tier is associated with a predetermined number of credits for a given time period, potentially on a recurring basis. Accordingly, rather than directly purchasing a vehicle reservation, the customer may exchange credits associated with his or her user account for a vehicle reservation via the vehicle reservation platform. If the user account has an insufficient credit balance, the customer may purchase additional credits in order to address the deficiency. In examples, a credit cost of a vehicle reservation is static or may be determined dynamically based on a variety of factors.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system for a vehicle reservation platform.

FIG. 2 illustrates an overview of an example region in which vehicle reservations are performed using aspects of the vehicle reservation platform described herein.

FIG. 3A illustrates an overview of an example method for vehicle reservation by a customer device.

FIG. 3B illustrates an overview of an example method for generating a vehicle reservation by a vehicle reservation platform.

FIG. 4 illustrates an overview of an example method for fulfilling a reservation by an inventory partner of a vehicle reservation platform.

FIGS. 5A-5C illustrate example user interface aspects of a vehicle reservation platform according to aspects of the present disclosure.

FIG. 6A illustrates an overview of an example method for generating a credit associated with a user account.

FIG. 6B illustrates an overview of an example method for processing an indication to apply credit according to aspects described herein.

FIG. 7 illustrates a diagram of a computing system for implementing a vehicle reservation platform.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, various barriers may complicate or otherwise prevent a user's access to special-purpose vehicles. Example barriers include, but are not limited to, ownership costs, maintenance costs, potentially complex vehicle transport logistics, storage space requirements, and/or storage costs. As a result of such barriers, the user may avoid vehicle ownership, engage in associated powersport activities at a reduced frequency, or even forego powersport activities entirely. Example special-purpose vehicles include utility vehicles and recreational vehicles. For example, a utility vehicle may be a low-speed vehicle (e.g., a golf cart), a lawn mower, or a fleet vehicle. As another example, a recreational vehicle may be an all-terrain vehicle (ATV), a side-by-side (SxS) vehicle, a utility vehicle, a motorcycle, a slingshot (SLG), a tricycle, a snowmobile, or watercraft.

Accordingly, aspects of the present disclosure relate to a vehicle reservation platform. In examples, the reservation platform offers one or more subscription tiers. A subscription tier is associated with a predetermined number of credits for a given time period, potentially on a recurring basis. For example, a first tier may provide three credits every month, while a second tier may provide six credits every three months. A subscription tier may have a predetermined term (e.g., weekly for a month, monthly for six months, quarterly for a year). A user may have a user account for the vehicle reservation platform, wherein the user account is associated with a subscription tier offered by the vehicle reservation platform. Credits that are unused within a given time period may be retained by the user's account, thereby enabling later use. For example, if a user subscribes to a subscription tier that provides three credits per month and the user only uses one credit, two credits remain associated with the user account and are available for future use. It will be appreciated that, in other examples, credits may expire (e.g., after the given time period or after a different predetermined time period).

As used herein, a “credit” serves as an intermediary between a subscription membership cost (e.g., on a post-paid or pre-paid basis) and an ability to reserve vehicles via the vehicle reservation platform. Further, it will be appreciated that alternative examples of the disclosed aspects may instead use points or tokens, or, as another example, may be more directly associated with vehicle reservations (e.g., one full-day reservation per month or one two-day reservation per quarter). While examples are described with respect to one or more credits, it will be appreciated that a credit need not be a whole number and may instead be fractional (e.g., a user may receive 0.25 credits or may spend 1.5 credits).

The vehicle reservation platform has an inventory of vehicles available for reservation. The inventory may comprise one or more types of special-purpose vehicles. Accordingly, a user of the vehicle reservation platform may reserve a vehicle from the inventory using credits associated with user account. If a credit amount associated with a vehicle reservation is greater than the amount of credits associated with the user account, the user may purchase additional credits. The option to purchase credits separate from those offered by a subscription tier may be restricted to users that subscribe to the vehicle reservation platform, such that non-subscribers maybe unable to directly purchase credits for their respective user accounts. In other examples, since credits may be acquired on a recurring basis and may “roll over” to subsequent time periods, a user may opt to save credits in order to ultimately afford the vehicle reservation.

In examples, at least a part of the inventory of vehicles is provided by the vehicle reservation platform and/or by one or more third parties, which may be referred to herein as “inventory partners.” For example, an inventory partner may be a vehicle distributor (e.g., a third party that sells special-purpose vehicles) that may make vehicles available via the vehicle reservation platform. Another example inventory partner is a vehicle outfitter (e.g., a third party that offers guided/self-guided tours using special-purpose vehicles) may make vehicles available via the vehicle reservation platform. An inventory partner may receive a fee or a percentage of reservation proceeds as a result of providing inventory to the vehicle reservation platform.

The vehicle reservation platform may provide different reservation types. For example, a pickup reservation type, a delivery reservation type, a guided reservation type, or a self-guided reservation type. An inventory partner may provide a subset of available reservation types and need not provide reservations of every reservation type that is available via the reservation platform. For example, a vehicle distributor may offer one set of reservation types (e.g., pickup and delivery), while a vehicle outfitter may offer a different set of reservation types (e.g., guided and self-guided tours). While example inventory partners are described herein, it will be appreciated that inventory available via the vehicle reservation platform may be provided by any of a variety of other third parties. For example, an individual may provide inventory and offer associated vehicle reservations via the vehicle reservation platform.

A credit cost associated with a vehicle may be determined according to any of a variety of techniques. For example, a credit cost may be determined according to vehicle type (e.g., make, model, passenger capacity, cargo capacity, or capabilities), vehicle location (e.g., whether the location is urban or rural, etc.), or vehicle age. As another example, the credit cost may be generated dynamically according to any of a variety of historical and/or predicted factors, including, but not limited to, demand for a certain vehicle type, seasonal or holiday demand, reservation type, or the proximity of available vehicles to a user. In some examples, different pricing techniques are used for different subscription tiers. For example, prices associated with one tier may be determined according to static techniques, while prices for another tier are determined dynamically. As another example, a subscription tier may receive reduced pricing.

A user may receive credits via mechanisms other than a subscription to the vehicle reservation platform. In examples, a user may own a special-purpose vehicle and may receive one or more credits while the special-purpose vehicle is undergoing maintenance. Thus, the user may continue to engage in powersport activities via the vehicle reservation platform while the special-purpose vehicle is being serviced. In other examples, the user may retain the credits for later use. As another example, a user may receive one or more credits in exchange for referring another user to the vehicle reservation platform, for attending an event, or as part of a trial membership or loyalty program, among other examples.

In some instances, a user may request cancellation of a subscription to the vehicle reservation platform. If cancellation is requested prior to expiration of the subscription term (e.g., in the fourth month of a six-month subscription), a cancellation fee may be assessed to the user. In other examples, the cancellation fee may be applied toward vehicle ownership, thereby enabling the user to effectively “convert′ a subscription membership to the vehicle reservation platform into vehicle ownership. Similarly, credits associated with the user's account may be applied toward vehicle ownership. Thus, a cancellation fee, a pro-rated subscription cost, and/or remaining credits associated with the user's account may be used to reduce a purchase price associated with a vehicle accordingly.

While examples herein are described with respect to a balance of credits and applying one or more such credits, it will be appreciated that each credit need not be fungible and may instead be uniquely identifiable. For example, a credit may have an associated serial number or unique identifier. Such a credit may have a set of credit attributes, including, but not limited to, a value, a date and/or time of origin, a source indicating what resulted in creation of the credit, and/or an expiration date and/or time. Though two credits may be uniquely identifiable according to an associated serial number or unique identifier, it will be appreciated that two credits need not have different sets of credit attributes.

As used herein, a “uniquely identifiable credit” is a credit having an associated serial number or other identifier. It will be appreciated that such a uniquely identifiable credit need not be uniquely identifiable from the perspective of the user and may instead appear the same as or similar to other credits associated with a user account. Additionally, a uniquely identifiable credit need not be globally unique and may instead be uniquely identifiable as compared to one or more other credits associated with the same user account, among other examples.

A value credit attribute may provide information associated with a context in which the credit was generated. For example, the value credit attribute may indicate a cost that was incurred (e.g., by a user) to obtain the credit, for example as a result of a subscription, a trial membership, a loyalty program, attending an event, or for referring another user, among other examples. Thus, while two credits may be similarly redeemed according to aspects described herein, they may each have different value credit attributes, thereby enabling an associated determination as to an actual credit value associated with a transaction, among any of a variety of other determinations based on one or more associated credit attributes.

As an example, a first credit may have a value credit attribute indicating it is a promotional credit (e.g., having a nominal associated value), while a second credit may have a value credit attribute indicating it was a credit generated in association with a user account as a result of a subscription (e.g., having a value associated with a membership tier). In examples, both credits may be applied together (e.g., for a reservation or other item/service costing two or more credits) or separately (e.g., for two such items or services). When a user applies a credit balance, a set of credits may be determined (e.g., based at least in part on a user selection, automatically, or a combination thereof, among other examples) and applied accordingly.

The value credit attribute associated with each credit may enable a determination as to one or more metrics, for example when a set of credits is applied or when determining a credit balance for a user account. For example, a realization metric may be determined based on totaling the value credit attribute for each credit of the set of applied credits and comparing the total value to a cost of one or more items/services for which the set of credits was applied. Similarly, the total value may be used to more accurately apply a set credits toward an item/service (e.g., for which the user has insufficient credits), as may be the case when a user applies a set of credits toward vehicle ownership according to aspects described herein, among other examples. Thus, as compared to a balance-based evaluation, for which an average credit value may be used, aspects described herein may more accurately determine a total value for the set of credits based on an associated value credit attribute for each credit.

In some examples, it may be determined that only a subset of credits can be applied toward a given item or service based on associated credit attributes, as may be the case when a given credit has passed its expiration date or an item/service can only be obtained using a non-promotional credit. As another example, it may be determined that a total value of the credits is below a cost of an item/service for which the set of credits would be redeemed. In such instances, it may be determined whether a different set of credits could be applied for the transaction (e.g., having a total value that is closer to or at least equal to the cost) or such a transaction may not be made available for user selection.

Credit attributes according to aspects described herein may be used for any of a variety of other processing. For example, an expiration date credit attribute may be used to determine whether to expire or remove a credit associated with a user account. In another example, an expiration date credit attribute may cause a value credit attribute to be updated as a result of the date/time indicated by the expiration date credit having passed.

A user may transfer at least a part of their credit balance from one user account to another user account. The user may be able to select a set of uniquely identifiable credits for transfer or, as another example, the set of credits may be automatically determined using any of a variety of techniques, examples of which are discussed in below. In some instances, one or more credit attributes may be updated as a result of the transfer. For example, a credit attribute may be set to indicate the user from which the credit was transferred. As another example, a value credit attribute may be decremented or otherwise changed as a result of the transfer. In some instances, a credit may be transferred a predetermined number of times, after which it may no longer be transferred. In such instances, an associated credit attribute may be updated to decrement an amount of remaining transfers. While example credit attributes are described, it will be appreciated that additional, alternative, or fewer credit attributes may be used in other examples.

Thus, as compared to more simple balance-based credit processing, aspects described herein may enable a level of granularity and the generation of associated metrics that would otherwise be difficult or impossible to achieve. Further, given the context in which a credit is generated may change over time (e.g., according to region or locale, based on changes to membership options, or based on any of a variety of other factors), maintaining a set of credit attributes for each credit may enable additional processing based on such factors. For example, credits generated for a first context (e.g., in a region or at a first time) may have a lower associated value than credits generated for a second context (e.g., in a different region or at a second time), such that a realization metric for a transaction in the first region may differ from a realization metric for a transaction in the second region, even though the transaction is for the same or a similar item/service.

While examples are described in the context of a subscription vehicle reservation platform and associated special-purpose vehicles, it will be appreciated that aspects described herein may be applied in any of a variety of other contexts. For example, a set of credits may be applied for a different subscription (e.g., to software and/or physical items), to unlock software or hardware functionality, for one or more accessories, and/or in exchange for vehicle maintenance, among other examples.

As another example, a credit balance may be managed according to aspects described herein in a hospitality scenario or as part of a loyalty program (e.g., where a user earns credits as a result of interactions and/or credits may expire or decrease in value over time as described herein), among other examples. The user may thus similarly apply credits to various aspects of an experience, including lodging, dining, and/or any of a variety of other amenities. In some examples, the user's credit balance may include uniquely identifiable credits of different types, for example as may be applied specifically to dining or one or more amenities. In other examples, it will be appreciated that a user's credit balance need not be specifically applicable to a given set of items/services. Rather, each experience may instead have an associated credit amount. The user may acquire credits in such an example as a result of a loyalty program, subscription, and/or referrals, among other examples.

Thus, the vehicle reservation platform described herein facilitates easy and convenient vehicle reservations according to a subscription model. A user reserves a special-purpose vehicle using credits associated with a user account (e.g., that were acquired according to an associated subscription tier). In response, the vehicle reservation platform programmatically coordinates logistics (e.g., with either a first or a third party) associated with the vehicle reservation. Such aspects reduce or resolve barriers that are traditionally associated with access to special-purpose vehicles and associated powersport activities, thereby enabling a larger population of users to engage in such activities and utilize special-purpose vehicles via the disclosed vehicle reservation platform.

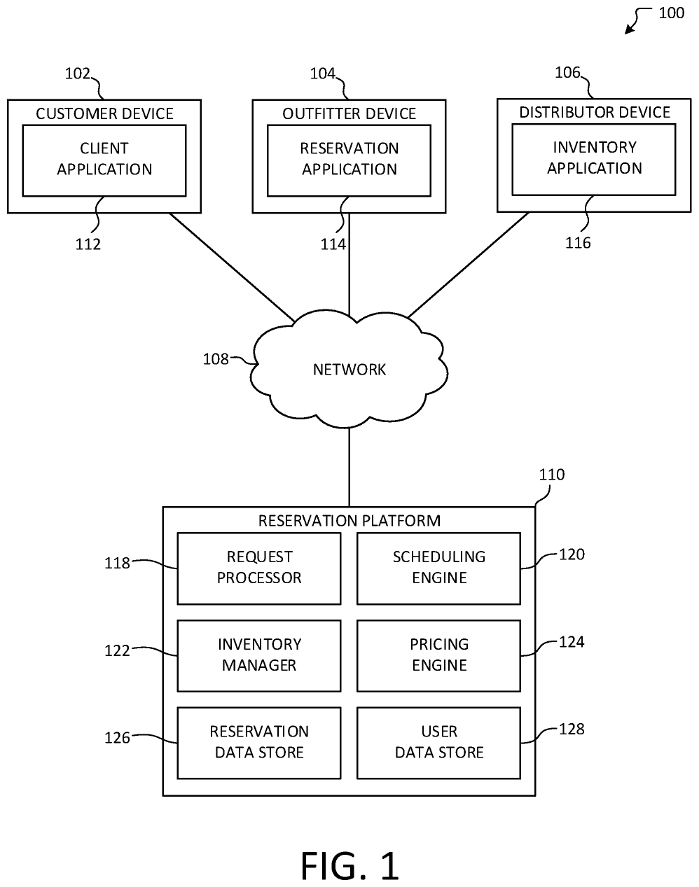

FIG. 1 illustrates an overview of an example system 100 for a vehicle reservation platform. As illustrated, system 100 comprises customer device 102, outfitter device 104, distributor device 106, network 108, and reservation platform 110. In examples, customer device 102, outfitter device 104, distributor device 106, and reservation platform 110 communicate via network 108, which may comprise a local area network, a wireless network, or the Internet, or any combination thereof, among other examples.

Reservation platform 110 may be a server computing device or may be a set of computing devices that form a distributed computing device. Customer device 102, outfitter device 104, and distributor device 106 may each be any of a variety of computing devices, including, but not limited to, a mobile computing device, a laptop computing device, a tablet computing device, or a desktop computing device. It will be appreciated that while system 100 is illustrated as comprising one reservation platform 110 and three devices 102, 104, and 106, any number of such elements may be used in other examples. Further, the functionality described herein with respect to reservation platform 110 and devices 102, 104, and 106 may be distributed among or otherwise implemented on any number of different computing devices in any of a variety of other configurations in other examples.

Reservation platform 110 is illustrated as comprising request processor 118, scheduling engine 120, inventory manager 122, pricing engine 124, reservation data store 126, and user data store 128. In examples, request processor 118 communicates with one or more other devices (e.g., applications 112, 114, and 116 of devices 102, 104, and 106, respectively) to provide aspects of the vehicle reservation platform described herein. Request processor 118 provides indications as to available inventory (and, in some examples, an associated credit cost for vehicles therein, as may be determined by pricing engine 124), receives reservation requests associated with available inventory, receives inventory and reservation updates from inventory partners, and provides reservation updates, among other functionality. For example, request processor 118 may generate a website (e.g., which may be accessed by application 112, 114, and/or 116) with which to manage a membership, reserve a vehicle, make inventory available for reservations, and/or manage reservation fulfilment, among other examples. In other examples, request processor 118 provides an application programming interface (API) (e.g., which may be used by application 112, 114, and/or 116) to perform such aspects as an alternative or in addition to a website. Thus, it will be appreciated that any of a variety of techniques may be used to communicate with reservation platform 110.

Scheduling engine 120 generates, modifies, deletes, tracks, or otherwise manages vehicle reservations of reservation platform 110. In examples, vehicle reservations are stored in reservation data store 126. An indication of a reservation may be received from client application 112 of customer device 102. The vehicle reservation may be associated with a user account (e.g., of user data store 128) and may have one or more associated vehicles, a reservation time (e.g., comprising a time range or one or more dates) and/or reservation types (e.g., pickup, delivery, a guided tour, or a self-guided tour). In some instances, a vehicle reservation is associated with multiple user accounts, thereby enabling multiple users to reserve one or more vehicles together. A credit balance associated with the user's account may be decremented accordingly and, in some instances, an indication to purchase additional credits may be processed accordingly.

In some instances, scheduling engine 120 (in conjunction with request processor 118) provides a reservation indication to reservation application 114 of outfitter device 104 or inventory application 116 of distributor device 106, thereby alerting an outfitter or a distributor of a reservation request from a user of reservation platform 110. In other examples, scheduling engine 120 receives an update indication from outfitter device 104 or distributor device 106 associated with a user's reservation. In response, scheduling engine 120 may update a reservation in reservation data store 126 and/or may generate an indication that is provided to customer device 102.

Inventory manager 122 manages the inventory that is available via reservation platform 110. Returning to the example above, inventory manager 122 may remove one or more vehicles from inventory that are associated with the vehicle reservation from client application 112, thereby ensuring another user does not place a reservation for the same set of vehicles at the same time. Additionally, or alternatively, inventory manager 122 may remove one or more vehicles from inventory that are being serviced. Additionally, or alternatively, inventory manager 122 may add one or more vehicles to the inventory that are returned by a customer and/or purchased by an outfitter and/or manufactured by a distributor. Inventory manager 122 may also process indications from reservation application 114 and/or inventory application 116. For example, reservation application 114 may indicate that an outfitter associated with outfitter device 114 has independently processed a reservation for a vehicle, such that the vehicle is not available via reservation platform 110 at a certain date and time. As another example, inventory application 116 may indicate that a distributor associated with distributor device 106 has sold a vehicle, such that reservations may no longer be placed for the vehicle. Thus, it will be appreciated that inventory manager 122 may process any of a variety of indications (e.g., associated with a user of reservation platform 110 or from any of a variety of inventory partners) in order to maintain an accurate inventory of vehicles that are available for reservation.

Pricing engine 124 may generate credit costs for vehicle reservations of reservation platform 110. In examples, pricing engine 124 generates a static credit cost for a vehicle reservation, for example based on vehicle type (e.g., make, model, passenger capacity, cargo capacity, or capabilities), vehicle location (e.g., whether the location is urban or rural, etc.), or vehicle age. In other examples, pricing engine 124 generates a dynamic credit cost for a vehicle reservation according to any of a variety of historical and/or predicted factors, including, but not limited to, demand for a certain vehicle type, seasonal or holiday demand, reservation type, or the proximity of available vehicles to a user. Thus, pricing engine 124 may generate credit costs for vehicle reservations associated with an inventory of vehicles according to a schedule or in response to any of a variety of events. For example, credit costs may be generated by pricing engine 124 as vehicles are added to the inventory of vehicles and/or in response to a request for currently available inventory (e.g., as may be received by request processor 118 from client application 112 of customer device 102), among other examples.

In examples, pricing engine 124 my generate a dynamic credit cost according to a set of credits associated with a user account, for example based on an associated value credit attribute and/or any of a variety of other credit attributes. Similarly, pricing engine 124 may determine a set of credits to apply from the credit balance of a user in response to a user indication, for example based at least in part on a user indication, automatically, or a combination thereof.

User data store 128 stores user accounts of reservation platform 110. As discussed above, request processor 118 processes requests associated with membership to reservation platform 110. For example, a request to subscribe to reservation platform 110 may be received as part of a registration process, which may indicate a subscription tier. Accordingly, a user account is generated in user data store 128 that indicates the user's selected subscription tier. The user account may further comprise billing information (e.g., credit card information and a billing address), contact information (e.g., an email address, a phone number, and/or a mailing address), and/or renewal preferences (e.g., whether the subscription should automatically renew or whether a renewal notice should be sent prior to renewal).

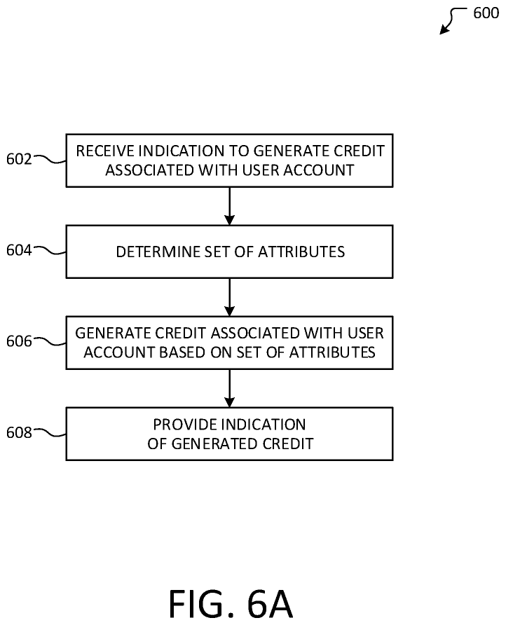

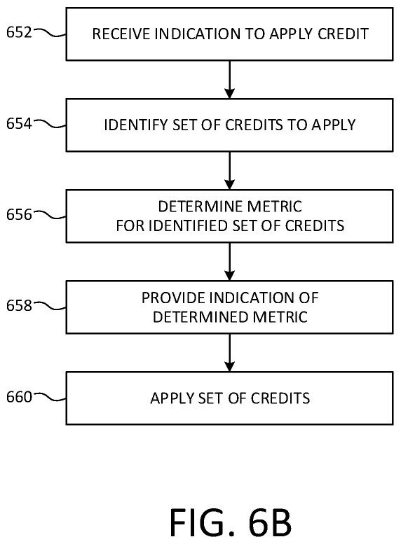

Reservation platform 110 may periodically add credit to a user account of user data store 128. As discussed above, a subscription tier may provide a predetermined number of credits for a given time period. Accordingly, when an amount of time greater than the predetermined time period has passed, reservation platform 110 increments a credit balance of the user account according to the predetermined number of credits for the user's subscription tier (as may be indicated by the subscription tier associated with the user account). In other examples, reservation platform 110 generates a uniquely identifiable credit and associates the generated credit with a user account, examples of which are discussed in greater detail below with respect to FIG. 6A. For example, a first user may subscribe to a tier that receives one credit per month, a second user may subscribe to a second tier that receives three credits per month, and a third user may subscribe to a third tier that receives nine credits per month. Each tier may have an associated term, such as a 12-month term for the first and second tiers and a six-month term for the third tier. It will be appreciated that the tiers and associated costs, credit amounts, time periods, and term periods are provided for illustrative purposes and, in other examples, other tiers may be used.

It will be appreciated that tiers may scale linearly or non-linearly. For example, the first tier may cost $99/month for one credit ($99 per credit), while the second tier may cost $249/month for three credits ($83 per credit). Thus, the second user receives a discount of $50/month for the three-credit tier as compared to the cost per credit of the first tier. Similarly, the third tier may cost $699/month for nine credits ($77.67 per credit), such that the third user receives three times as many credits as the second tier, but spends less than three times as much. When credits are used to reserve a vehicle, a credit balance of a user account is decremented according to the credit cost of the reserved vehicle according to aspects described herein. Users may use credits during the period in which they are received or may retain credits for later use. For example, the third user may spend all nine credits each month. As another example, the second user may retain three months of credits (e.g., three credits per month, according to the second subscription tier) to ultimately place an equivalent set of reservations (e.g., costing nine credits) as the third user places in one month.

In some instances, credits may be transferrable between user accounts. For example, a first user may send at least a portion of a credit balance to a second user, such that the credit balance of user account of the first user is decreased by an amount that is similar to a corresponding increase in the credit balance of the user account of the second user. In some instances, a fee (e.g., in absolute terms or as a percentage) may be subtracted from the transferred amount, such that the full credit balance is not transferred from the first user to the second user. In other instances, two users may “pool” their respective credit balances, such that a reservation may be placed utilizing credit balances of multiple user accounts. An associated credit cost for one or more vehicles of such a group reservation may be split evenly among the multiple user accounts or according to any other division, as may be determined by the users.

As noted above, one or more credit attributes may be added, removed, or modified as a result of a credit transfer between user accounts. Further, in examples where a credit cost is divided among multiple user accounts, the processing discussed above with respect to uniquely identifiable credits may be performed based on the set of credits contributed by each user. For example, a realization metric may be determined based on the total value for the set of credits from each user in view of a cost of one or more items/services for which the set of credits was applied (e.g., a group reservation of one or more special purpose vehicles). In other examples, rather than a group realization metric (and/or other metrics), a realization metric may be calculated on an individual basis or according to any of a variety of other groupings (e.g., by region, by last name, or by membership duration).

It will be appreciated that a user account need not be associated with a single individual and, in some examples, may instead be associated with a group of individuals (e.g., a couple, a family, etc.). As part of the registration process, an executed waiver may be received for one or more individuals and subsequently associated with the user account accordingly. Emergency contact information and/or insurance information may also be stored as part of the user account, among other information. In examples, the user account further comprises an amount of credits that are available for placing vehicle reservations according to aspects described herein. The amount may be incremented on a periodic basis, as may be determined based on the subscription tier associated with the user account. In some examples, a pre-existing user account may be used. For example, another platform or service may already have at least a part of the information that would typically be requested from a user, such that it may be copied or otherwise incorporated into a user account for the vehicle reservation platform.

Customer device 102 is illustrated as comprising client application 112. In examples, client application 112 is a web browser, a native application, or a combination thereof. As discussed above, client application 112 communicates with reservation platform 110 to perform the vehicle reservation aspects described herein. For example, client application 112 facilitates a registration process, in which a set of available subscription tiers are presented to a user, thereby enabling a user to select a subscription tier and create a user account accordingly. Similarly, client application 112 may present a waiver and collect a user's electronic signature, among other information (e.g., billing information, contact information, and/or emergency contact information).

Client application 112 may generate a display of available vehicles, thereby enabling a user to reserve a vehicle. In examples, client application 112 receives a set of available vehicles from an inventory of reservation platform 110 (e.g., as may be generated by request processor 118 in conjunction with scheduling engine 120, inventory manager 122, and/or pricing engine 124). The set of available vehicles may be filtered (e.g., at customer device 102 or by reservation platform 110) based at least in part on a set of filter criteria. The set of filter criteria may be determined at reservation platform 110 and/or provided by the user of customer device 102. Example filter criteria include, but are not limited to, vehicle type (e.g., make, model, passenger capacity, cargo capacity, or capabilities), vehicle location (e.g., located at or within a predetermined range of a geographic location), availability information (e.g., a certain date and/or time, or whether a vehicle is available for a specified number of days), and/or user account information (e.g., whether sufficient credits are associated with the user account or whether restrictions affect availability of certain vehicles or reservations during certain seasons). While example filters are discussed herein, it will be appreciated that additional, alternative, or fewer filters may be used in other examples.

The user places a vehicle reservation using client application 112. Accordingly, client application 112 communicates with reservation platform 110 to generate a reservation in reservation data store 126 according to aspects described. An amount of credits associated with the user account may be decreased accordingly. In examples where the reserved vehicle is provided by an inventory partner, an indication may be provided to the partner accordingly (e.g., to outfitter device 104 or distributor device 106). Client application 112 and reservation platform 110 may further enable a user to extend a reservation (e.g., from a full-day reservation to an over-night reservation). The credit balance associated with the user account may be decremented accordingly or, in other examples, the user may purchase additional credits as described herein.

In some examples, decrementing a credit balance of a user account may include applying a specific set of uniquely identifiable credits from the credit balance of the user account according to aspects described herein. For example, a user may provide an indication of one or more credits to apply, such that the indicated credits are applied accordingly. Example indications include, but are not limited to, an indication of a specific credit, an indication to apply a credit that is expiring soon, or an indication to apply a credit that was obtained in a specific context (e.g., as a result of a subscription, a trial membership, a loyalty program, attending an event, or for referring another user).

In such instances, a user interface presenting at least some of the credits associated with the user's account may be displayed, such that the user may select one or more of the presented credits. In other examples, a user interface element may be presented that indicates the user has one or more credits that are nearing expiration, such that the user may actuate the user interface element to indicate such credits should be applied before other credits associated with the user account. While example user interface aspects and associated behaviors are disclosed, it will be appreciated that any of a variety of other user experience paradigms may be used.

In other examples, one or more credits may be automatically determined, for example as a result of evaluating one or more credit attributes using any of a variety of criteria. As an example, credits may be automatically applied according to a first-in, first-out (FIFO) methodology, such that decrementing a user's credit balance comprises identifying one or more oldest credits. As another example, credits may be determined according to associated value credit attributes, where credits having either the lowest or the highest value credit attribute are applied before other credits of the user's credit balance. In some instances, a combination of manual selection and automatic credit determination may be used. Thus, it will be appreciated that any of a variety of techniques may be used to determine a set of credits to apply according to aspects described herein.

System 100 further comprises outfitter device 104 and distributor device 106, which are used by inventory partners of reservation platform 110 to make inventory available via the reservation platform and otherwise manage associated reservations. In examples, reservation application 114 and inventory application 116 communicate with request processor 118 of reservation platform 110 to manage the inventory of vehicles that are available via each respective inventory partner. For example, reservation application 114 and inventory application 116 may provide indications as to inventory that is no longer available (e.g., as a result of reservations independent of reservation platform 110 or sold inventory). Additionally, reservation application 114 and inventory application may receive indications of reservations that are placed via reservation platform 110, thereby enabling each respective inventory partner to fulfill the reservation. For example, reservation application 114 may subsequently assign a guide to a reservation having a guided reservation type or, as another example, inventory application 116 may organize delivery logistics associated with a reservation having a delivery reservation type. While example inventory partner interactions are described herein, other techniques may be used. For example, rather than automatically assigning reservations to an inventory partner, inventory partners may access a list of scheduled reservations and select one or more reservations to fulfill.

In some examples, reservation application 114 and inventory application 116 enable reservation updates to be provided, which may be communicated to customer device 102 and/or stored for auditing purposes. In some examples, distributor device 106 is a mobile device or otherwise communicates with a mobile device of a delivery driver, thereby enabling customer device 102 to provide a substantially real-time view of the location of a user's vehicle delivery reservation. It will be appreciated that reservation application 114 and inventory application 116 need not provide similar functionality and may instead each provide a subset of the above-described features or may further provide additional or alternative features. Additionally, reservation application 114 and inventory application 116 need not be standalone applications. Rather, such functionality may instead be integrated into other software in other examples.

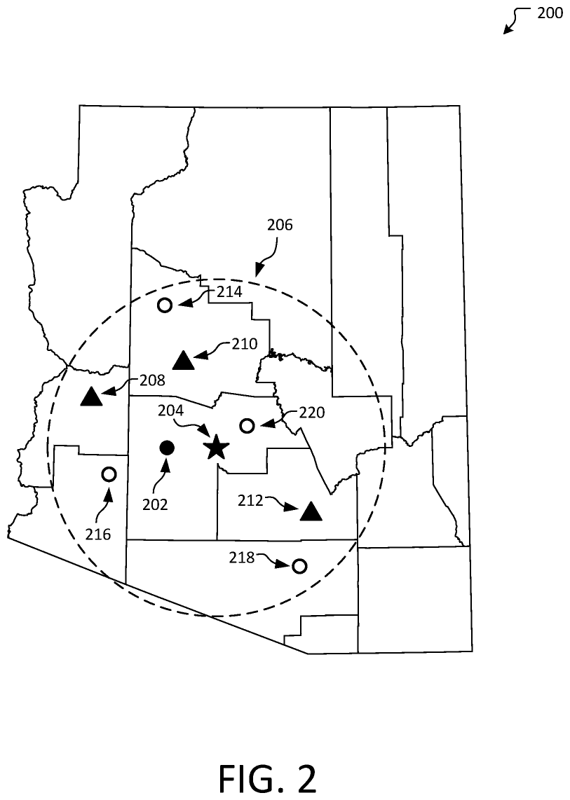

FIG. 2 illustrates an overview of an example region 200 in which vehicle reservations are performed using aspects of the vehicle reservation platform described herein. As illustrated, region 200 comprises user location 202, city 204, service area 206, inventory partners 208, 210, and 212, and trailheads 214, 216, 218, and 220. In some instances, a customer application (e.g., customer application 112 of customer device 102 in FIG. 1) generates a display similar to that of region 200.

In examples, a vehicle reservation platform (e.g., reservation platform 110 in FIG. 1) enables a user to place a vehicle reservation within a service area. For example, service area 206 represents a two-hour drive time from city 204. Thus, the user may place a vehicle delivery reservation for any location within service area 206. While service area 206 is illustrated as a circle centered on city 204, it will be appreciated that a service area may take any of a variety of shapes according to any of a variety of constraints. As another example, each respective inventory partner may have an associated service area. Additionally, it will be appreciated that while the user is located at user location 202, the user need not be restricted to reservations within service area 206. Rather, the user may place vehicle reservations at any of a variety of other locations and associated service areas. For example, the user may place a vehicle reservation for a vehicle in a different state or within a service area of another city.

Inventory partners 208, 210, and 212 may be distributors and/or outfitters, among other examples. Vehicles of inventory partners 208, 210, and 212 are available for reservation via the reservation platform described herein. For example, the user may place a pickup reservation at inventory partner 208, such that the user may drive from user location 202 to inventory partner 208 in order to pick up the vehicle for the duration of the vehicle reservation. As another example, the user may place a delivery reservation from inventory partner 210, whereby inventory partner 210 receives an indication to deliver the vehicle to user location 202 or to another location of the user's choosing.

In some instances, the user may instead select trailhead 214, 216, 218, or 220, such that an inventory partner receives an indication to deliver the vehicle to the trailhead accordingly. In such instances, the reservation platform may identify an inventory partner that is proximate to the selected trailhead and has a requested vehicle in inventory (and, in some instances, an available guide) to fulfill the reservation. For example, inventory partner 212 may be selected to deliver a vehicle to trailhead 218, while inventory partner 210 may be selected to deliver a vehicle to trailhead 214. In some instances, inventory partners may be equidistant to a trailhead (e.g., inventory partners 210 and 212 in relation to trailhead 220). In such instances, reservation platform may evaluate the inventory of each inventory partner to determine which inventory partner has the most available inventory. It will be appreciated that any of a variety of additional or alternative factors may be evaluated, such as historical or forecasted demand, as well as estimated drive time associated with vehicle delivery.

In some instances, a credit cost associated with a vehicle reservation is determined dynamically (e.g., by a pricing engine, such as pricing engine 124 in FIG. 1). For example, a credit cost associated with vehicle delivery to trailhead 218 may be less than a credit cost associated with vehicle delivery to trailhead 220, as inventory partner 212 is closer to trailhead 218 than trailhead 220. As another example, a credit cost associated with vehicle delivery to trailhead 220 on a given date may increase as available inventory decreases. For example, inventory partners 210 and 212 (which are most proximate to trailhead 220) may have no remaining inventory, and a credit cost for delivery from inventory partner 208 may be comparatively more expensive as a result of its distance from trailhead 220.

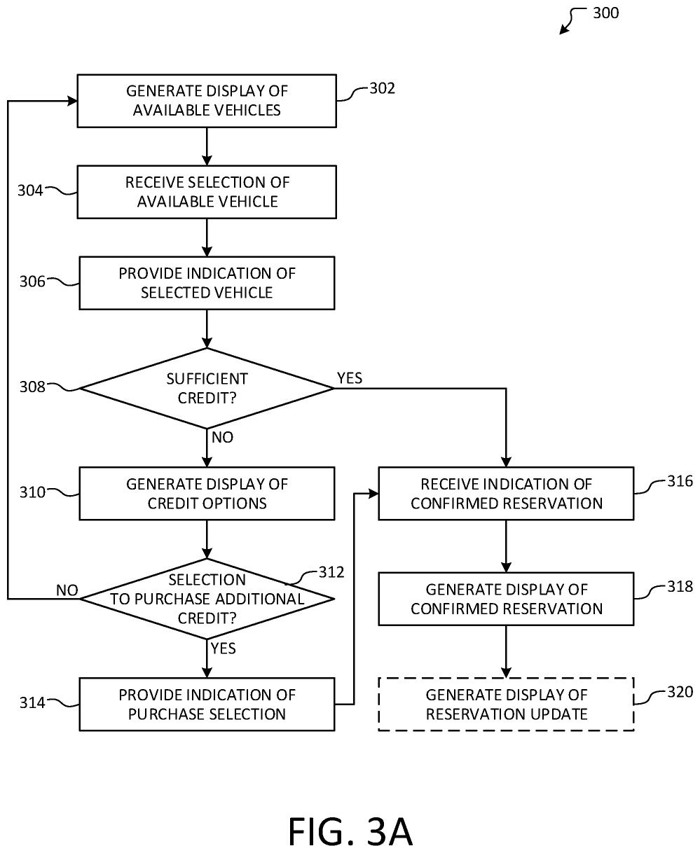

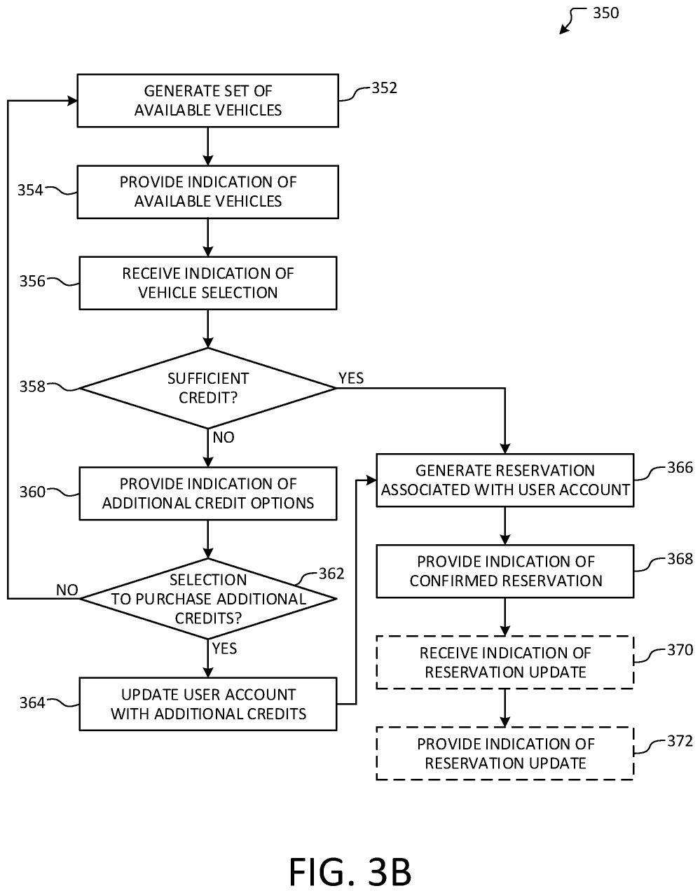

FIG. 3A illustrates an overview of an example method 300 for vehicle reservation by a customer device, such as customer device 102 in FIG. 1. Aspects of method 300 may be performed by a client application, such as client application 112 in FIG. 1. Method 300 begins at operation 302, where a display of available vehicles is generated. The display may be part of a website or a mobile application, among other examples. Vehicles may be displayed in association with a credit cost for reserving a respective vehicle, as may be determined statically or dynamically according to aspects described herein. The available vehicles may be received from a reservation platform, such as reservation platform 110 in FIG. 1.

In some instances, the set of available vehicles is received in response to a request by the customer device. For example, the request may comprise a user location, a set of filter criteria (e.g., a vehicle type, a date/time, passenger/cargo capacity, and/or capabilities), and/or a session identifier associated with a user account. In examples, only a subset of available vehicles is displayed. For example, the available vehicles may be filtered according to any of a variety of criteria. In other examples, the available vehicles are filtered by the reservation platform instead of or in addition to filtering performed by the customer device. In some instances, the display of available vehicles is similar to region 200 in FIG. 2 or, in other examples, the display may comprise a list as an alternative to or in addition to a map. The list may be sorted according to credit cost, proximity to the user, or popularity, among other examples.

At operation 304, a selection of an available vehicle is received from a user. The user may select a vehicle by clicking or tapping on one of the vehicles that was displayed at operation 302. It will be appreciated that any of a variety of other user input techniques may be used in other examples, such as using voice input or a software or hardware keyboard. In some instances, additional information is requested from the user, such a desired delivery location, pickup time slot, or number of days for the reservation. In instances where a user's account does not have an associated waiver or the waiver associated with the user account is expired, the user may be prompted to re-execute a waiver. It will be appreciated that any of a variety of additional or alternative information may be requested from the user at operation 304 and may be based at least in part on the user's vehicle selection.

Flow progresses to operation 306, where an indication of the selected vehicle is provided to the reservation platform. For example, the indication comprises the vehicle selection, an associated date/time for the reservation, and/or additional information that was requested from the user at operation 304. In some instances, the indication is provided by submitting a form on a website or using an API, among other examples. The indication may be provided to generate a temporary reservation for the selected vehicle, thereby ensuring another user does not complete the vehicle reservation process before the instant user. In an example, the reservation platform may indicate that the user's account has insufficient credits to complete the reservation.

In examples, the display generated at operation 302 may further comprise an indication of one or more uniquely identifiable credits, as may be selected by the user (e.g., at operation 304) according to aspects described herein. In other examples, a prompt may be generated (e.g., as a result of a received selection at operation 304), which enables the user to select one or more credits or, as another example, to provide an indication to apply one or more credits that are expiring soon. Accordingly, operation 306 may further comprise providing an indication associated with such user input (e.g., an indication of a selected credit or to apply one or more credits that are expiring soon, among other examples). Such a display or prompt may be selectively presented, for example when the user has a credit that is near expiration (e.g., below a predetermined threshold number of days). In other examples, it may be determined that no credits are expiring soon or that each credit associated with the user account has the same or similar credit attributes, such that the user is not presented with the ability to provide such indications.

Accordingly, at determination 308, it is determined whether the user's account has a sufficient credit to reserve the selected vehicle. In examples, the determination comprises evaluating a response that was received to the indication that was provided at operation 306, which may indicate additional credit is required. In other examples, the determination comprises evaluating the vehicle selection that was received at operation 304 as compared to the user account (e.g., as may be requested from the reservation platform or as may be cached on the customer device).

If it is determined that the user does not have sufficient credit, flow branches “NO” to operation 310, where a display of credit options is generated. The display may comprise one or more options to supplement the credit balance associated with the user account. In examples, the display is based on a set of credit options that is received from the reservation platform. As an example, the generated display comprises an option to purchase the difference in credits between the credit associated with the user account and the credit cost of the selected vehicle.

At determination 312, it is determined whether a selection was received to purchase additional credit. If it is determined that the user did not select to purchase additional credit, flow branches “NO” to operation 302, where a display of available vehicles is again presented to the user, thereby enabling selection of a different vehicle (e.g., one that has a credit cost that is the same or below the credit balance of the user account). If, however, it is determined that the user selected to purchase additional credit, flow instead branches “YES” to operation 314, where an indication of the purchase selection is provided to the reservation platform. In examples, the indication may comprise billing information or, in other examples, the user's billing information is stored in the user account. Accordingly, the reservation platform processes the transaction and flow progresses to operation 316, which is discussed below.

Returning to determination 308, if it is determined that the user has enough credit, flow instead branches “YES” and moves from determination 308 to operation 316, where an indication of a confirmed reservation is received. In examples, the indication comprises a confirmation number, reservation instructions (e.g., pickup instructions, delivery instructions, guided/self-guided tour instructions), an availability estimate (e.g., an estimated delivery time or an estimated pickup time after which the vehicle is available for pickup), and/or a remaining credit balance associated with the user account.

Flow progresses to operation 318, where a display is generated of the confirmed reservation. The display may comprise any of a variety of information that was received at operation 316. For example, the display may comprise the confirmation number, at least a part of the reservation instructions, the availability estimate, and/or the remaining credit balance. In examples, the display further comprises a map associated with a pickup location (e.g., of an inventory partner), a trailhead location, or a delivery location. Operation 320 is illustrated using a dash box to indicate that, in some instances, method 300 terminates at operation 318.

In other instances, flow progresses to operation 320, where a display of a reservation update is generated. For example, the reservation platform may provide an indication as to a location of a delivery driver or an indication that a vehicle pickup reservation is ready for pickup, among other examples, such that the display generated at operation 320 reflects the reservation update accordingly. As another example, a notification may be generated as an alternative to or in addition to generating the updated display. It will be appreciated that operation 320 may be performed any number of times. Further, while example user interface and user experience aspects are described, any of a variety of similar techniques may be used to enable a user to place a reservation, purchase additional credit, and view reservation status for a vehicle reservation platform according to aspects of the present disclosure. Flow eventually terminates at operation 320.

FIG. 3B illustrates an overview of an example method 350 for generating a vehicle reservation by a vehicle reservation platform. In examples, aspects of method 350 are performed by a reservation platform, such as reservation platform 110 in FIG. 1. Method 350 begins at operation 352, where a set of available vehicles is generated. Aspects of operation 352 may be performed by a scheduling engine, such as scheduling engine 120 in FIG. 1. In some instances, the set of available vehicles is generated based on information received as part of a request from a customer device (e.g., customer device 102 in FIG. 1). For example, the request may comprise a user location, a set of filter criteria (e.g., a vehicle type, a date/time, passenger/cargo capacity, and/or capabilities), and/or a session identifier associated with a user account. The generated set of available vehicles may be filtered according to any of a variety of criteria. In other examples, the available vehicles are filtered by a customer device instead of or in addition to filtering performed by the reservation platform.

Flow progresses to operation 354, where an indication of available vehicles is provided to a customer device. In examples, the indication comprises a credit cost for each available vehicle therein (e.g., as may be generated by a pricing engine, such as pricing engine 124 in FIG. 1). In other examples, the indication comprises only a subset of available vehicles. For example, the set of available vehicles may be provided as multiple pages of a website or may be provided in the context of a map (e.g., similar to region 200 in FIG. 2), which may be filtered based at least in part on proximity to a user's location, among other examples. In other examples, the generated set of available vehicles is provided via an API, among other techniques.

At operation 356, an indication of a vehicle selection is received. The indication may be received via a request processor, such as request processor 118 in FIG. 1. In examples, the indication is received as a result of a customer device performing aspects of operation 306 of method 300 in FIG. 3A. The indication may further comprise an associated date/time for the reservation and/or additional information associated with the user. In some instances, the indication is received as a result of submitting a form on a website or via an API, among other examples.

As noted above, user input may be received associated with one or more uniquely identifiable credits according to aspects described herein. Accordingly, the indication received at operation 356 may further comprise an indication of such user input. Similarly, determination 358 discussed below may comprise determining a set of credits associated with a user account that will be applied for the vehicle reservation. The set of credits may be determined based on user input (e.g., based on the indication of user input that may be received at operation 356) and/or automatically, or any combination thereof, according to aspects described herein.

At determination 358, it is determined whether there is sufficient credit associated with the user account to place the reservation for the vehicle that was indicated at operation 356. In examples, the determination comprises comparing a credit balance associated with a user account and a credit cost for the vehicle (e.g., as may be generated by a pricing engine, such as pricing engine 124 in FIG. 1).

If it is determined that the user does not have sufficient credit, flow branches “NO” to operation 360, where an indication of additional credit options is provided (e.g., as may be displayed by a customer device performing aspects of operation 310 of method 300 in FIG. 3A). As an example, an additional credit option may comprise an option to purchase the difference in credits between the credits of a user's account and the credit cost of the selected vehicle. In some instances, additional options may be provided.

At determination 362, it is determined whether a user selected to purchase additional credits. If it is determined that the user did not select to purchase additional credits, flow branches “NO” to operation 352, where a set of available vehicles is generated. In some examples, flow may instead branch “NO” to operation 356, where a new indication of vehicle selection is received. For example, the customer device may cache the set of available vehicles that was previously provided at operation 354, such that flow instead branches to operation 356.

In some instances, determination 362 comprises receiving an indication of purchase selection (e.g., as may be provided by a customer device performing aspects of operation 314 of method 300 in FIG. 3A). The indication may comprise billing information or, in other examples, billing information may be accessed from a user account (e.g., as may be stored by a user data store, such as user data store 128 in FIG. 1). Accordingly, flow branches “YES” to operation 364, where a user account is updated to reflect the credits that were purchased by the user. In examples, updating the user account may comprise generating one or more uniquely identifiable credits associated with the user account according to aspects described herein. In some instances, aspects of operation 364 further comprises processing a payment associated with the purchase of credits, as may be processed according to payment information that was received as part of the indication or that is stored as part of the user account, among other examples. Flow then continues to operation 366, which is discussed below.

Returning to operation 358, if it is determined that the user has sufficient credit, flow instead branches “YES” to operation 366, where a reservation is generated and associated with the user account. Thus, payment need not be processed for the vehicle reservation as a result of credits that are associated with the user account. Indeed, in examples where the user has sufficient credits, payment need not be processed at all. Additionally, in instances where additional credit is purchased, the credit balance of the user account may be incremented according to the credit purchase and subsequently decremented to complete the vehicle reservation. Thus, as described above, the credit balance of the user account may serve as an intermediary between a monetary cost associated with the subscription membership (as well as additional credit purchases) and a user's ability to reserve vehicles via the vehicle reservation platform. In examples, updating the user account may comprise applying a set of uniquely identifiable credits (e.g., as may have been manually selected and/or automatically determined), such that the credits are no longer associated with the user account and/or are updated to indicate that they have been applied and are therefore not available for use in the future. Aspects of operation 366 may be performed by a scheduling engine, such as scheduling engine 120 in FIG. 1. For example, a reservation is generated in a reservation data store (e.g., reservation data store 126 in FIG. 1) and associated with a user account in a user data store (e.g., user data store 128).

Flow progresses to operation 368, where an indication of the confirmed reservation is provided to the customer device. The indication may comprise a confirmation number, reservation instructions (e.g., pickup instructions, delivery instructions, guided/self-guided tour instructions), an availability estimate (e.g., an estimated delivery time or an estimated pickup time after which the vehicle is available for pickup), and/or a remaining credit balance associated with the user account. In some instances, an indication is provided to an inventory partner (e.g., an outfitter or a distributor), as may be received by an outfitter device or a distributor device, such as outfitter device 104 or distributor device 106 in FIG. 1. The indication may enable the inventory partner to perform actions associated with fulfilling the reservation. Operations 370 and 372 are illustrated using dashed boxes to indicate that, in some examples, method 350 terminates at operation 368.

However, in other examples, flow progresses to operation 370, where an indication of a reservation update is received from an inventory partner (e.g., to which an indication was provided at operation 368). For example, the indication may relate to a delivery reservation (e.g., a location of a delivery driver) or may comprise an indication that a vehicle pickup reservation is ready for pickup, among other examples. Accordingly, at operation 372, an indication of the reservation update is provided to the customer device. In some instances, operation 372 further comprises updating a reservation in a reservation data store accordingly based on the reservation update. Operations 720 and 372 may be performed any number of times as updates are received from an inventory partner. Flow eventually terminates at operation 372.

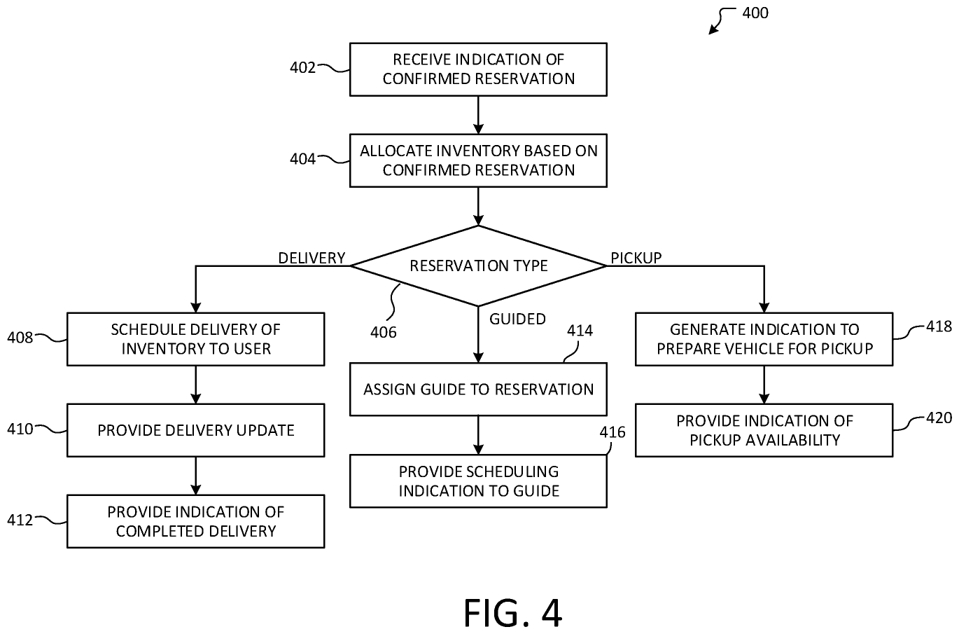

FIG. 4 illustrates an overview of an example method 400 for fulfilling a reservation by an inventory partner of a vehicle reservation platform. In examples, aspects of method 400 may be performed by an outfitter device or a distributor device, such as outfitter device 104 or distributor device 106, respectively, in FIG. 1. Method 400 begins at operation 402, where an indication of a confirmed reservation is received. In examples, the indication is received from a reservation platform, such as reservation platform 110 in FIG. 1. The reservation platform may be performing aspects of operation 368 of method 300 in FIG. 3B.

Flow progresses to operation 404, where inventory is allocated based on the confirmed reservation. In examples, operation 404 comprises communicating with a separate reservation and/or inventory system to associate a vehicle in the separate system with the vehicle indicated by the confirmed reservation. In other examples, operation 404 may comprise providing an indication to the vehicle reservation platform that the reservation is accepted by the inventory partner.

Method 400 branches at determination 406 depending on the reservation type. If the reservation is a delivery reservation, flow branches “DELIVERY” to operation 408, where delivery of the inventory is scheduled. For example, a delivery vehicle (and, in some instances, and associated driver) may be identified and associated with the confirmed reservation. An indication may be provided to a mobile device of a delivery driver accordingly.

Flow progresses to operation 410, where a delivery update is provided to the reservation platform. In examples, operation 410 may be performed multiple times, thereby enabling a customer to track a delivery vehicle associated with a vehicle reservation. The delivery update may be received as a reservation update by the reservation platform, for example at operation 370 of method 350 in FIG. 3B. Eventually, flow progresses to operation 412, where an indication of completed delivery is provided. The indication may again be provided to the reservation platform (e.g., at operation 370). Flow terminates at operation 412.

In other examples, if the reservation is a guided reservation, flow instead branches “GUIDED” from determination 406 to operation 414, where a guide is assigned to the reservation. The guide may be assigned based on a calendar of available guides or via a separate reservation system, among other examples. Flow progresses to operation 416, where a scheduling indication is provided to the guide (e.g., as a text message, an email, or via a scheduling portal). While example scheduling techniques are described, it will be appreciated that any of a variety of other aspects may be utilized to provide such functionality. For example, the reservation platform may further provide guide-scheduling capabilities or, as another example, may provide delivery capabilities discussed above with respect to operation 408. Flow terminates at operation 416.

Finally, if, at determination 406, the reservation is a pickup reservation, flow branches “PICKUP” to operation 418, where an indication is generated to prepare a vehicle for pickup. For example, the indication may be generated in a queue or other order tracking system, thereby enabling an individual of the inventory partner to fulfill the pickup order accordingly. Eventually, flow progresses to operation 420, where an indication of pickup availability is provided to the reservation platform. For example, a device (e.g., outfitter device 104 or distributor device 106 in FIG. 1) may be used by the individual to provide the indication accordingly. Flow terminates at operation 420.

While method 400 is illustrated with respect to three order types, it will be appreciated that fewer, additional, or alternative order types may be used. Additionally, all three order types illustrated in method 400 need not be implemented. For example, reservation application 114 of outfitter device 104 in FIG. 1 may implement operations 402-406 and 414-420, while inventory application 116 of distributor device 106 may implement operations 402-412.

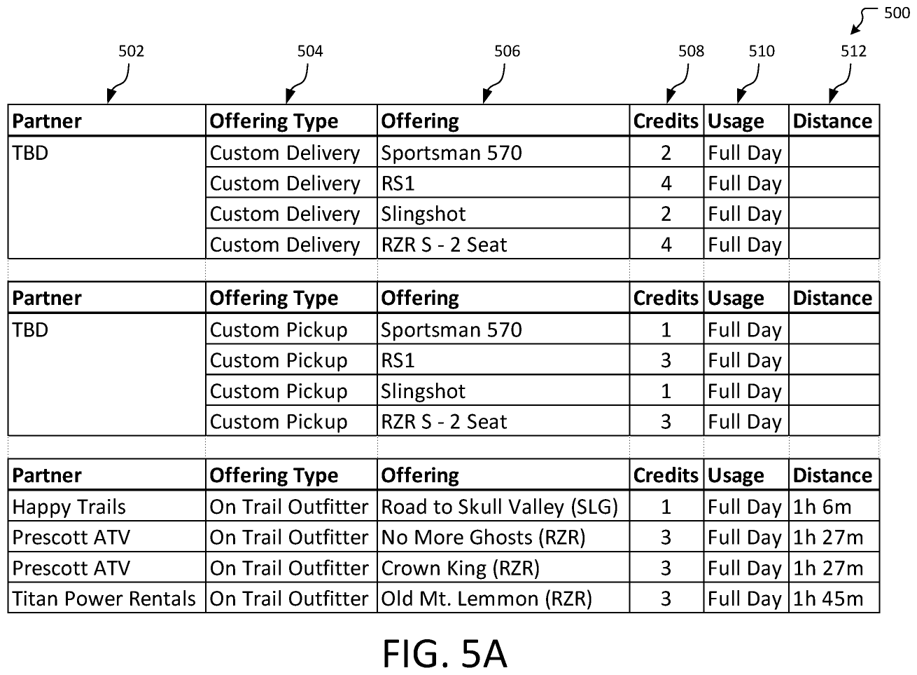

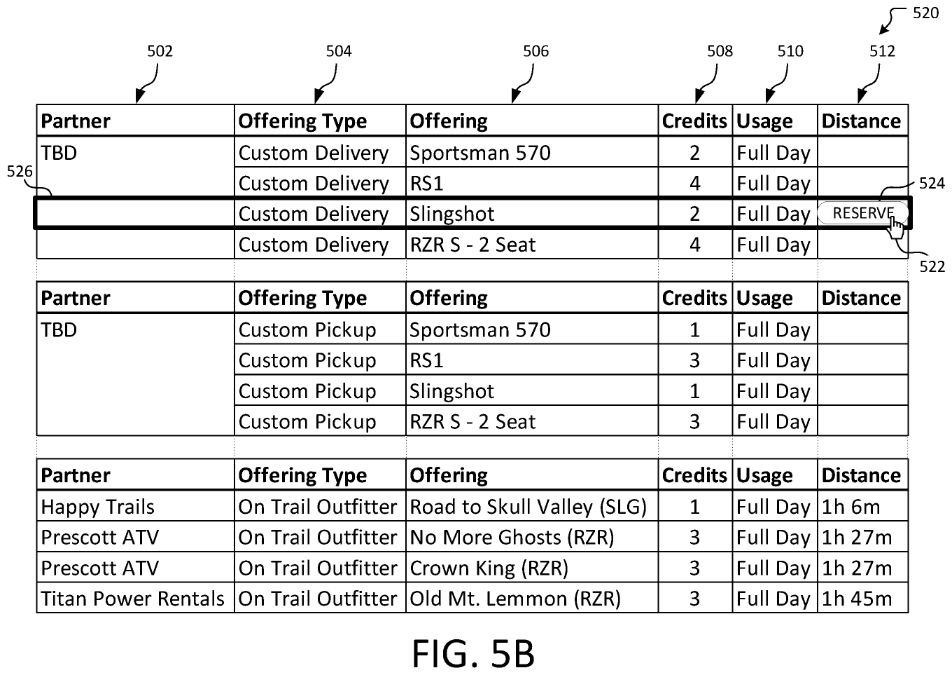

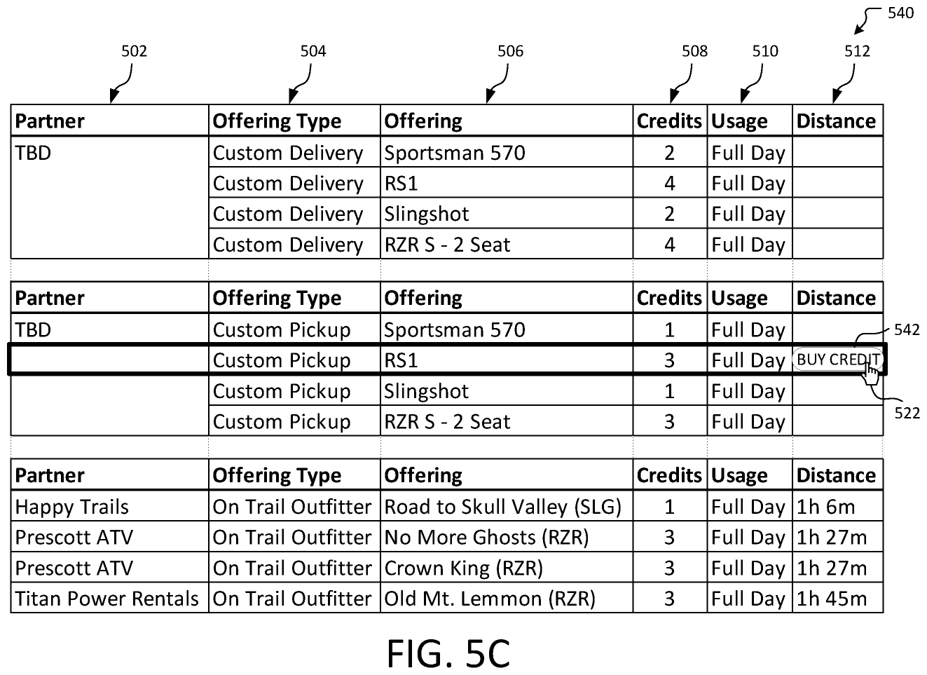

FIGS. 5A-5C illustrate example user interface aspects of a vehicle reservation platform. FIGS. 5A-5C comprise similar elements and associated reference numerals, and are therefore not necessarily re-described in detail with respect to subsequent figures. With reference to FIG. 5A, user interface 500 comprises inventory partner column 502, offering type column 504, offering column 506, credit cost column 508, reservation period column 510, and distance column 512. User interface 500 may have been generated as a result of a customer device performing aspects of operation 302 of method 300 in FIG. 3A. Vehicles listed in user interface 500 may have been determined as a result of a reservation platform performing aspects of operation 352 of method 350 in FIG. 3B.

User interface 500 is sorted according to reservation type, as illustrated by offering type column 504 (e.g., “Custom Delivery,” “Custom Pickup,” and “On Trail Outfitter”). While example reservation types are disclosed, it will be appreciated that additional, fewer, or alternative types may be used in other examples. Inventory partner column 502 comprises an indication as to an inventory partner (e.g., inventory partners 208, 210, and 212 in FIG. 2) associated with an available vehicle. Offering column 506 indicates a vehicle type (e.g., “Sportsman 570,” “Slingshot,” “RZR,” “SLG,” etc.) and, in some examples, a trailhead (e.g., trailheads 214, 216, 218, and 220 in FIG. 2) associated with a vehicle reservation. Credits column 508 indicates a credit cost associated with a vehicle reservation. As discussed above, credits column 508 may comprise a static credit cost and/or a dynamic credit cost for a vehicle reservation, as may be determined by a pricing engine, such as pricing engine 124 in FIG. 1.

Reservation period column 510 indicates a time length associated with a vehicle reservation. As discussed above, a user may filter available vehicles based on a number of days for which a vehicle is available. For example, user interface 500 may display a filtered list of vehicles that are available for a “full day,” while other vehicles may be available for multiple days or for half days, among other examples. Distance column 512 indicates a distance from the user (e.g., user location 202 as compared to a distance to one of inventory partners 208, 210, or 212, or trailheads 214, 216, 218, or 220 in FIG. 2). No distance is shown for “Custom Delivery” or “Custom Pickup” types, as the user may specify a location for such reservation types.

FIG. 5B illustrates an example user interface 520 in which a pointer 522 is hovering over vehicle reservation 526. As a result, reserve button 524 is displayed. Accordingly, a user may use pointer 522 to click reserve button 524 in order to initiate a reservation process, which may comprise aspects of method 300 discussed above with respect to FIG. 3A. While example aspects are described with respect to using pointer 522, it will be appreciated that similar techniques may be used for instances where alternate input methods are available, such as touch input or keyboard input. In other examples, the illustrated list may be numbered, such that a user may identify a reservation using an associated number. As another example, a voice user interface may be used, with which a user may select a vehicle reservation based on words associated with the vehicle reservation (e.g., saying “the on trail option provided by Happy Trails” or “a custom pickup reservation of an RS1”).

User interface 540 illustrates an example in which a user has insufficient credit to reserve a vehicle. Accordingly, rather than displaying reserve button 524, buy credit button 542 is displayed instead. As a result, the user may click the button to purchase additional credit according to aspects described herein, thereby enabling the user to complete the reservation process after purchasing additional credit. Similar to FIG. 5B, alternate input techniques may be used. For example, a user may say “purchase additional credit for the custom RS1 pickup” or may tap and hold on the vehicle reservation in order to access an associated menu of options, in which an option to purchase additional credit may be presented.

Thus, while example user interface and user experience techniques are described herein, it will be appreciated that any of a variety of other techniques may be used according to aspects described herein. For example, while user interfaces 500, 520, and 540 are illustrated as having a list of vehicles, it will be appreciated that, in other examples, a user interface may further comprise a map, similar to that of region 200 in FIG. 2. In other examples a user interface may comprise such a map instead of the illustrated list of vehicles.

FIG. 6A illustrates an overview of an example method 600 for generating a credit associated with a user account. In examples, aspects of method 600 are performed by a reservation platform, such as reservation platform 110 discussed above with respect to FIG. 1.

Method 600 begins at operation 602, where an indication is received to generate a credit associated with a user account. In examples, the indication is received when a predetermined time period has passed, as may be the case when the user account is associated with a subscription. In another example, the indication may be received as a result of processing payment information received from a user (e.g., similar to aspects discussed above with respect to operations 314 and/or 364 of FIGS. 3A and 3B, respectively) or as a result of user attendance at an event, among other examples. While aspects of method 600 are described with respect to generating a single credit, it will be appreciated that similar techniques may be used to generate multiple credits.

At operation 604, a set of credit attributes are determined. For example, the set of credit attributes may include a value (e.g., associated with a context in which the credit is being generated), a date and/or time of origin, a source indicating what resulted in creation of the credit, and/or an expiration date and/or time. As discussed above, the value credit attribute may indicate a cost that was incurred (e.g., by a user) to obtain the credit, for example as a result of a subscription, a trial membership, a loyalty program, attending an event, or for referring another user, among other examples. While example credit attributes are described, it will be appreciated that any of a variety of other credit attributes may be determined at operation 604 in other examples.

Flow progresses to operation 606, where a credit is generated in association with the user account based on the generated set of attributes. For example, the credit may be generated in a data store, such as user data store 128 discussed above with respect to FIG. 1. The credit may be stored as part of a user account or, as another example, the user account may be updated to include a reference to the generated credit (e.g., according to a serial number or unique identifier, among other examples). While example generation and storage techniques are described, it will be appreciated that any of a variety of other techniques may be used, for example providing the credit or information associated therewith for storage by a user device.

At operation 608, an indication of the generated credit is provided. For example, the indication may include a serial number or unique identifier and/or one or more credit attributes, among other examples. In some instances, the indication may cause processing by the reservation platform to continue (e.g., as may be the case when a user account had insufficient credits to complete a reservation) or may be provided to a customer device (e.g., as may be the case when a user acquires an additional credit), among other examples. Method 600 terminates at operation 608.

FIG. 6B illustrates an overview of an example method 650 for processing an indication to apply credit according to aspects described herein. In examples, aspects of method 650 are performed by a reservation platform, such as reservation platform 110 discussed above with respect to FIG. 1.

Method 650 begins at operation 652, where an indication to apply a credit is received. For example, the indication may be received as a result of an indication of a vehicle selected by a user, as discussed above with respect to operations 306-314 of method 300 in FIG. 3A. As another example, the indication may be received as a result of processing such an indication, examples of which were discussed above with respect to operations 356-366 of method 350 in FIG. 3B. While examples are discussed in the context of a reservation platform, it will be appreciated that similar techniques may be used in any of a variety of other contexts.

Flow progresses to operation 654, where a set of credits is identified. In examples, an indication of a user selection of one or more credits is received at operation 652, such that at least a part of the set of credits identified at operation 654 includes such user-selected credits. In other examples, at least a part of the identified set of credits is automatically determined, for example based on an expiration date and/or an associated value credit attribute. As another example, the set of credits may be automatically determined based on an indication of a user selection, for example to apply credits that are approaching expiration. While example techniques for identifying a set of credits are described, it will be appreciated that additional or alternative criteria and/or processing may be used in other examples.

At operation 656, a metric is determined for the identified set of credits. For example, a realization metric may be generated according to a value credit attribute associated with each credit of the identified set of credits. In other examples, operation 656 comprises processing additional or alternative credit attributes associated with each credit of the identified set of credits, such that additional or alternative metrics may be determined in association with the credit being applied.

At operation 658, an indication of the determined metric is provided. For example, the indication may be provided to a data store, such that the metric may be stored for subsequent evaluation (e.g., by a user associated with a customer device or a user associated with the reservation platform, among other examples). In examples, the indication may be provided as part of a report that is generated based at least in part on the metric that is determined at operation 656.

Moving to operation 660, the identified set of credits is applied. For example, the set of credits may be disassociated with the user account and, in some examples deleted. As another example, the set of credits may remain associated with the user account but a credit attribute of each credit may be updated to indicate that it has been applied. In some instances, a credit attribute may be added to indicate that the credit was applied for one or more items and/or services. Method 650 terminates at operation 660. While method 650 is described in an example where such processing (e.g., discussed above with respect to operations 656 and/or 658) occurs as part of applying a credit, it will be appreciated that similar processing may be performed before or after a credit is applied in other examples.

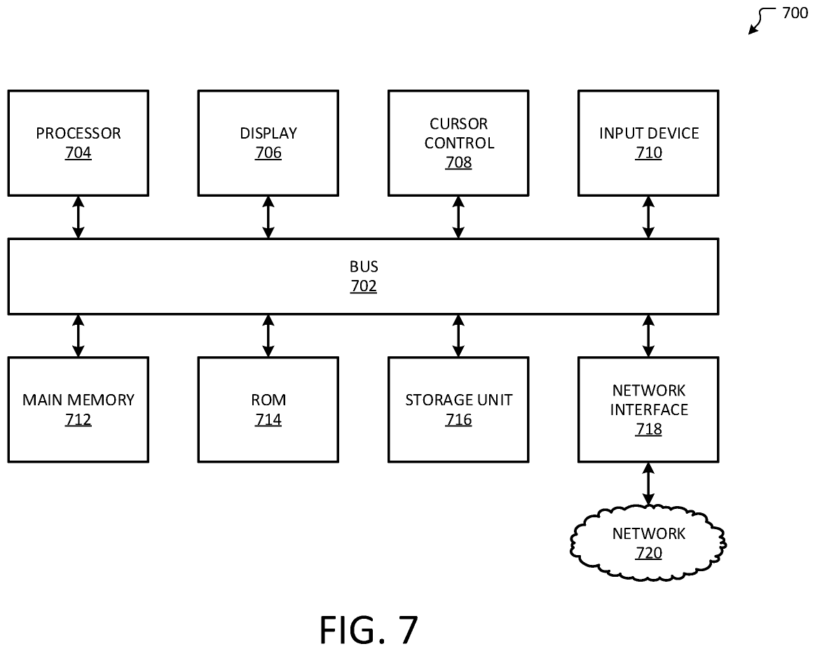

FIG. 7 illustrates a diagram of a computing system 700 for implementing a system for scheduling special-purpose vehicle services. For example, some or all of the functions of reservation platform 110 (e.g., comprising request processor 118, scheduling engine 120, inventory manager 122, pricing engine 124, reservation data store 126, and user data store 128), customer device 102, outfitter device 104, and/or distributor device 106 may be performed by a computing system that has similar components as the computing system 700. This diagram is merely an example, which should not unduly limit the scope of the claims. One of ordinary skill in the art would recognize many variations, alternatives, and modifications.

The computing system 700 includes a bus 702 or other communication mechanism for communicating information between, a processor 704, a display 706, a cursor control component 708, an input device 710, a main memory 712, a read only memory (ROM) 714, a storage unit 716, and/or a network interface 718. In some examples, the bus 702 is coupled to the processor 704, the display 706, the cursor control component 708, the input device 710, the main memory 712, the read only memory (ROM) 714, the storage unit 716, and/or the network interface 718. And, in certain examples, the network interface 718 is coupled to a network 720 (e.g., the network 112).

In some examples, the processor 704 includes one or more general purpose microprocessors. In some examples, the main memory 712 (e.g., random access memory (RAM), cache and/or other dynamic storage devices) is configured to store information and instructions to be executed by the processor 704. In certain examples, the main memory 712 is configured to store temporary variables or other intermediate information during execution of instructions to be executed by processor 704. For example, the instructions, when stored in the storage unit 716 accessible to processor 704, render the computing system 700 into a special-purpose machine that is customized to perform the operations specified in the instructions (e.g., the components 112-128). In some examples, the ROM 714 is configured to store static information and instructions for the processor 704. In certain examples, the storage unit 716 (e.g., a magnetic disk, optical disk, or flash drive) is configured to store information and instructions.

Thus, computing system 700 may include at least some form of computer readable media. The computer readable media may be any available media that can be accessed by processor 704 or other devices. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may not include communication media.

In some embodiments, the display 706 (e.g., a cathode ray tube (CRT), an LCD display, or a touch screen) is configured to display information to a user of the computing system 700. In some examples, the input device 710 (e.g., alphanumeric and other keys) is configured to communicate information and commands to the processor 704. For example, the cursor control 708 (e.g., a mouse, a trackball, or cursor direction keys) is configured to communicate additional information and commands (e.g., to control cursor movements on the display 706) to the processor 704.

The following clauses are provided as example aspects of the disclosed subject matter:

1. A system comprising: at least one processor; and memory storing instructions that, when executed by the at least one processor, causes the system to perform a set of operations, the set of operations comprising: receiving, from a customer device, an indication to reserve a special-purpose vehicle, wherein the special-purpose vehicle is associated with a credit cost; determining a credit balance of a user account associated with the customer device; and when the credit cost associated with the special-purpose vehicle does not exceed the credit balance of the user account: updating the credit balance of the user account based on the credit cost associated with the special-purpose vehicle; and generating a reservation for the special-purpose vehicle, wherein the reservation is associated with the user account.

2. The system of clause 1, wherein the set of operations further comprises: when the credit cost associated with the special-purpose vehicle exceeds the credit balance of the user account: providing an indication that the credit balance of the user account is insufficient to reserve the special purpose vehicle; receiving an indication to purchase additional credit; associating additional credit with the user account; updating the credit balance of the user account based on the credit cost associated with the special-purpose vehicle; and generating a reservation for the special-purpose vehicle, wherein the reservation is associated with the user account.

3. The system of clause 2, wherein associating additional credit with the user account comprises: determining, based on a context associated with the indication to purchase additional credit, a set of credit attributes associated with the additional credit; generating the additional credit having the determined set of credit attributes and an identifier; and associating, based on the identifier, the generated credit with the user account.

4. The system of any one of clauses 1-3, wherein the credit cost associated with the special-purpose vehicle is dynamically determined based at least in part on one or more of: a historical demand for a vehicle type associated with the special-purpose vehicle; a predicted demand for the vehicle type; a historical seasonal demand; a predicted seasonal demand; a historical holiday demand; a predicted holiday demand; a reservation type associated with the indication to reserve the special-purpose vehicle; or a proximity of available special-purpose vehicles.

5. The system of any one of clauses 1-4, wherein the set of operations further comprises: providing, to an inventory partner associated with the special-purpose vehicle, an indication of the generated reservation.

6. The system of clause 5, wherein the set of operations further comprises: receiving, from the inventory partner, an indication of a reservation update; and providing, to the customer device, the indication of the reservation update.

7. The system of any one of clauses 5-6, wherein the set of operations further comprises: determining the inventory partner from a set of inventory partners that have the special-purpose vehicle in inventory.

8. The system of any one of clauses 1-7, wherein: the user account is associated with a subscription tier that provides a predetermined number of credits for a given time period; and the set of operations further comprises: based on determining an amount of time greater than the given time period has passed, increasing the credit balance of the user account by the predetermined number of credits.

9. The system of clause 8, wherein increasing the credit balance of the user account comprises: determining, based on a context associated with the subscription tier, a set of credit attributes associated with each of the predetermined number of credits; generating each credit of the predetermined number of credits having the determined set of credit attributes and an associated identifier; and associating, based on the identifier, each generated credit with the user account.

10. The system of any one of clauses 1-9, wherein updating the credit balance of the user account comprises: determining a set of credits from the credit balance of the user account; and applying the determined set of credits.

11. The system of clause 10, wherein updating the credit balance of the user account further comprises: generating a total value based on a value credit attribute for each credit of the determined set of credits; generating a realization metric based on the generated total value and a cost associated with the reservation for the special-purpose vehicle; and at least one of: providing an indication of the generated realization metric; or storing the generated realization metric.

12. The system of any one of clauses 10-11, wherein the set of credits is determined based in part on an indication of a user selection received from the customer device.

13. The system of any one of clauses 10-11, wherein the set of credits is determined automatically based on evaluating a credit attribute for a credit of the set of credits.

14. The system of any one of clauses 10-13, wherein applying the determined set of credits comprises: updating a credit attribute for each credit of the determined set of credits to indicate the credit has been applied; or disassociating each credit of the determined set of credits from the user account.

15. A method for reserving a special-purpose vehicle via a vehicle reservation platform, comprising: requesting a set of special-purpose vehicles from the vehicle reservation platform; receiving, from the vehicle reservation platform, the set of special-purpose vehicles; generating a display of special-purpose vehicles based on at least a part of the received set of special-purpose vehicles, wherein the display further comprises a credit balance of a user account; receiving a selection of a special-purpose vehicle, wherein the selected special-purpose is associated with a credit cost; providing an indication to the vehicle reservation platform to reserve the selected special-purpose vehicle; and receiving, from the vehicle reservation platform, a remaining credit balance for the user account and a reservation confirmation for the selected special-purpose vehicle.

16. The method of clause 15, further comprising: receiving, in response to the indication to reserve the selected special-purpose vehicle, an indication that the user account has insufficient credit to reserve the selected special-purpose vehicle; generating a display of a set of credit options to increase the credit balance of the user account; receiving a selection of a credit option from the set of credit options; and providing an indication of the selected credit option to the vehicle reservation platform.

17. The method of any one of clauses 15-16, further comprising: before providing the indication to the vehicle reservation platform to reserve the selected special-purpose vehicle: determining the credit cost associated with the special-purpose vehicle exceeds the credit balance of the user account; generating a display of a set of credit options to increase the credit balance of the user account; receiving a selection of a credit option from the set of credit options; and providing an indication of the selected credit option to the vehicle reservation platform.

18. The method of any one of clauses 15-17, further comprising: receiving, from the vehicle reservation platform, a reservation update associated with the reservation confirmation for the selected special-purpose vehicle; and generating a display based at least in part on the reservation update.

19. The method of clause 18, wherein the generated display based on the reservation update comprises a map indicating a location of a delivery vehicle.

20. The method of any one of clauses 15-19, wherein: the received selection of the special-purpose vehicle further comprises a selection of a reservation type; and the indication to the vehicle reservation platform to reserve the selected special-purpose vehicle further indicates the selected reservation type.

21. The method of any one of clauses 15-20, further comprising: receiving a selection to extend the reservation of the selected special-purpose vehicle; providing, to the vehicle reservation platform, an indication to extend the reservation of the selected special-purpose vehicle; and receiving, from the vehicle reservation platform, an updated remaining credit balance for the user account and an extended reservation confirmation for the selected special-purpose vehicle.

22. The method of any one of clauses 15-21, wherein: the display further comprises information associated with at least one credit of the credit balance of the user account; the method further comprises receiving user input associated with the credit balance of the user; and the provided indication to reserve the selected special-purpose vehicle further comprises an indication of the received user input.

23. The method of clause 22, wherein the user input comprises at least one of: a selection of a specific credit of the credit balance of the user; or an indication to apply a credit that is nearing expiration.

24. A method for processing, by an inventory partner, a vehicle reservation of a vehicle reservation platform, comprising: receiving, from the vehicle reservation platform, an indication of a reservation for a special-purpose vehicle, wherein the special-purpose vehicle is associated with the inventory partner and wherein the reservation indicates a date and time; updating an inventory of the inventory partner to indicate the special-purpose vehicle is unavailable for the date and time of the reservation; and providing, to the vehicle reservation platform, a reservation update indicating the special-purpose vehicle reservation has been fulfilled.

25. The method of clause 24, wherein the reservation update indicates one of: a customer picked up the special-purpose vehicle; the special-purpose vehicle was delivered to the customer; and a guide met the customer to begin a tour with the special-purpose vehicle.

26. The method of any one of clauses 24-25, wherein the reservation is a delivery reservation and the method further comprises: receiving, from a device of a delivery driver associated with delivery of the special-purpose vehicle, a location of the device; and providing, to the vehicle reservation platform, an indication of the location of the device.

27. The method of clause 26, further comprising: providing, to the vehicle reservation platform, a reservation update comprising an estimated delivery time of the special-purpose vehicle.

28. The method of any one of clauses 24-27, further comprising: providing, to the vehicle reservation platform, a reservation update comprising an estimated pickup time of the special-purpose vehicle.

29. The method of any one of clauses 24-27, further comprising: providing, to the vehicle reservation platform, an indication that the special-purpose vehicle is not available for reservation after the date indicated by the reservation.

30. A method for maintaining a user account associated with a user, the method comprising: based on determining to generate a credit for a credit balance of the user account: generating a set of credit attributes associated with the credit; generating the credit having the determined set of credit attributes and an identifier; and associating, based on the identifier, the generated credit with the user account; receiving an indication to apply the credit balance of the user account; and in response to the indication to apply the credit balance of the user account: determining a set of credits from the credit balance of the user account; and applying the determined set of credits.

31. The method of clause 30, wherein it is determined to generate the credit after a predetermined amount of time has elapsed.

32. The method of clause 30, wherein it is determined to generate the credit as a result of a user interaction associated with the user account.

33. The method of any one of clauses 30-32, wherein applying the determined set of credits comprises: updating a credit attribute for each credit of the determined set of credits to indicate the credit has been applied; or disassociating each credit of the determined set of credits from the user account.

34. The method of any one of clauses 30-33, further comprising, in response to the indication to apply the credit balance of the user account: generating a total value based on a value credit attribute for each credit of the determined set of credits; generating a realization metric based on the generated total value and a cost associated with the indication to apply the credit balance; and at least one of: providing an indication of the generated realization metric; or storing the generated realization metric.

35. The method of any one of clauses 30-34, wherein the set of credits is determined based in part on the received indication to apply the credit balance of the user account.

36. The method of any one of clauses 30-35, wherein the set of credits is determined automatically based on evaluating a credit attribute for one or more credits of the credit balance.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
receiving, from a customer device, an indication to reserve a special-purpose vehicle, wherein the special-purpose vehicle is associated with a credit cost;
determining a credit balance of a user account associated with the customer device; and
when the credit cost associated with the special-purpose vehicle does not exceed the credit balance of the user account:
updating the credit balance of the user account based on the credit cost associated with the special-purpose vehicle; and
generating a reservation for the special-purpose vehicle, wherein the reservation is associated with the user account.

2. The system of claim 1, wherein the set of operations further comprises:
when the credit cost associated with the special-purpose vehicle exceeds the credit balance of the user account:
providing an indication that the credit balance of the user account is insufficient to reserve the special purpose vehicle;
receiving an indication to purchase additional credit;
associating additional credit with the user account;
updating the credit balance of the user account based on the credit cost associated with the special-purpose vehicle; and
generating a reservation for the special-purpose vehicle, wherein the reservation is associated with the user account.

3. The system of claim 2, wherein associating additional credit with the user account comprises:
determining, based on a context associated with the indication to purchase additional credit, a set of credit attributes associated with the additional credit;
generating the additional credit having the determined set of credit attributes and an identifier; and
associating, based on the identifier, the generated credit with the user account.

4. The system of claim 1, wherein the credit cost associated with the special-purpose vehicle is dynamically determined based at least in part on one or more of:
a historical demand for a vehicle type associated with the special-purpose vehicle;
a predicted demand for the vehicle type;
a historical seasonal demand;
a predicted seasonal demand;
a historical holiday demand;
a predicted holiday demand;
a reservation type associated with the indication to reserve the special-purpose vehicle; or
a proximity of available special-purpose vehicles.

5. The system of claim 1, wherein the set of operations further comprises:
providing, to an inventory partner associated with the special-purpose vehicle, an indication of the generated reservation.

6. The system of claim 5, wherein the set of operations further comprises:
receiving, from the inventory partner, an indication of a reservation update; and
providing, to the customer device, the indication of the reservation update.

7. The system of claim 5, wherein the set of operations further comprises:
determining the inventory partner from a set of inventory partners that have the special-purpose vehicle in inventory.

8. The system of claim 1, wherein:
the user account is associated with a subscription tier that provides a predetermined number of credits for a given time period; and
the set of operations further comprises:
based on determining an amount of time greater than the given time period has passed, increasing the credit balance of the user account by the predetermined number of credits.

9. The system of claim 8, wherein increasing the credit balance of the user account comprises:
determining, based on a context associated with the subscription tier, a set of credit attributes associated with each of the predetermined number of credits;
generating each credit of the predetermined number of credits having the determined set of credit attributes and an associated identifier; and
associating, based on the identifier, each generated credit with the user account.

10. The system of claim 1, wherein updating the credit balance of the user account comprises:
determining a set of credits from the credit balance of the user account; and
applying the determined set of credits.

11. The system of claim 10, wherein updating the credit balance of the user account further comprises:
generating a total value based on a value credit attribute for each credit of the determined set of credits;
generating a realization metric based on the generated total value and a cost associated with the reservation for the special-purpose vehicle; and
at least one of:
providing an indication of the generated realization metric; or
storing the generated realization metric.

12. The system of claim 10, wherein the set of credits is determined based in part on an indication of a user selection received from the customer device.

13. The system of claim 10, wherein the set of credits is determined automatically based on evaluating a credit attribute for a credit of the set of credits.

14. The system of claim 10, wherein applying the determined set of credits comprises:
updating a credit attribute for each credit of the determined set of credits to indicate the credit has been applied; or
disassociating each credit of the determined set of credits from the user account.

15. A method for reserving a special-purpose vehicle via a vehicle reservation platform, comprising:
requesting a set of special-purpose vehicles from the vehicle reservation platform;
receiving, from the vehicle reservation platform, the set of special-purpose vehicles;
generating a display of special-purpose vehicles based on at least a part of the received set of special-purpose vehicles, wherein the display further comprises a credit balance of a user account;
receiving a selection of a special-purpose vehicle, wherein the selected special-purpose is associated with a credit cost;
providing an indication to the vehicle reservation platform to reserve the selected special-purpose vehicle; and
receiving, from the vehicle reservation platform, a remaining credit balance for the user account and a reservation confirmation for the selected special-purpose vehicle.

16. The method of claim 15, further comprising:
receiving, in response to the indication to reserve the selected special-purpose vehicle, an indication that the user account has insufficient credit to reserve the selected special-purpose vehicle;
generating a display of a set of credit options to increase the credit balance of the user account;
receiving a selection of a credit option from the set of credit options; and
providing an indication of the selected credit option to the vehicle reservation platform.

17. The method of claim 15, further comprising:
before providing the indication to the vehicle reservation platform to reserve the selected special-purpose vehicle:
determining the credit cost associated with the special-purpose vehicle exceeds the credit balance of the user account;
generating a display of a set of credit options to increase the credit balance of the user account;
receiving a selection of a credit option from the set of credit options; and
providing an indication of the selected credit option to the vehicle reservation platform.

18. The method of claim 15, further comprising:
receiving, from the vehicle reservation platform, a reservation update associated with the reservation confirmation for the selected special-purpose vehicle; and
generating a display based at least in part on the reservation update.

19. The method of claim 18, wherein the generated display based on the reservation update comprises a map indicating a location of a delivery vehicle.

20. The method of claim 15, wherein:
the received selection of the special-purpose vehicle further comprises a selection of a reservation type; and
the indication to the vehicle reservation platform to reserve the selected special-purpose vehicle further indicates the selected reservation type.

21. The method of claim 15, further comprising:
receiving a selection to extend the reservation of the selected special-purpose vehicle;
providing, to the vehicle reservation platform, an indication to extend the reservation of the selected special-purpose vehicle; and
receiving, from the vehicle reservation platform, an updated remaining credit balance for the user account and an extended reservation confirmation for the selected special-purpose vehicle.

22. The method of claim 15, wherein:
the display further comprises information associated with at least one credit of the credit balance of the user account;
the method further comprises receiving user input associated with the credit balance of the user; and
the provided indication to reserve the selected special-purpose vehicle further comprises an indication of the received user input.

23. The method of claim 22, wherein the user input comprises at least one of:
a selection of a specific credit of the credit balance of the user; or
an indication to apply a credit that is nearing expiration.

24. A method for processing, by an inventory partner, a vehicle reservation of a vehicle reservation platform, comprising:
receiving, from the vehicle reservation platform, an indication of a reservation for a special-purpose vehicle, wherein the special-purpose vehicle is associated with the inventory partner and wherein the reservation indicates a date and time;
updating an inventory of the inventory partner to indicate the special-purpose vehicle is unavailable for the date and time of the reservation; and
providing, to the vehicle reservation platform, a reservation update indicating the special-purpose vehicle reservation has been fulfilled.

25. The method of claim 24, wherein the reservation update indicates one of:
a customer picked up the special-purpose vehicle;
the special-purpose vehicle was delivered to the customer; and
a guide met the customer to begin a tour with the special-purpose vehicle.

26. The method of claim 24, wherein the reservation is a delivery reservation and the method further comprises:
receiving, from a device of a delivery driver associated with delivery of the special-purpose vehicle, a location of the device; and
providing, to the vehicle reservation platform, an indication of the location of the device.

27. The method of claim 26, further comprising:
providing, to the vehicle reservation platform, a reservation update comprising an estimated delivery time of the special-purpose vehicle.

28. The method of claim 24, further comprising:
providing, to the vehicle reservation platform, a reservation update comprising an estimated pickup time of the special-purpose vehicle.

29. The method of claim 24, further comprising:
providing, to the vehicle reservation platform, an indication that the special-purpose vehicle is not available for reservation after the date indicated by the reservation.

30. A method for maintaining a user account associated with a user, the method comprising:
based on determining to generate a credit for a credit balance of the user account:
generating a set of credit attributes associated with the credit;
generating the credit having the determined set of credit attributes and an identifier; and
associating, based on the identifier, the generated credit with the user account;
receiving an indication to apply the credit balance of the user account; and
in response to the indication to apply the credit balance of the user account:
determining a set of credits from the credit balance of the user account; and
applying the determined set of credits.

31. The method of claim 30, wherein it is determined to generate the credit after a predetermined amount of time has elapsed.

32. The method of claim 30, wherein it is determined to generate the credit as a result of a user interaction associated with the user account.

33. The method of claim 30, wherein applying the determined set of credits comprises:
updating a credit attribute for each credit of the determined set of credits to indicate the credit has been applied; or
disassociating each credit of the determined set of credits from the user account.

34. The method of claim 30, further comprising, in response to the indication to apply the credit balance of the user account:
generating a total value based on a value credit attribute for each credit of the determined set of credits;
generating a realization metric based on the generated total value and a cost associated with the indication to apply the credit balance; and
at least one of:
providing an indication of the generated realization metric; or
storing the generated realization metric.

35. The method of claim 30, wherein the set of credits is determined based in part on the received indication to apply the credit balance of the user account.

36. The method of claim 30, wherein the set of credits is determined automatically based on evaluating a credit attribute for one or more credits of the credit balance.
